(19) United States
(12) Patent Application Publication
(10) Pub. No.: US 2026/0184593 A1
(43) Pub. Date: Jul. 2, 2026

(54) METHOD OF SYNTHESIZING CORE-SHELL IRON OXIDE NBRIEF DESCRIPTION ANOPARTICLES THROUGH CONTINUOUS SYNTHESIS OF CORE AND SHELL IN SINGLE REACTION CHAMBER

(71) Applicant: UIF (University Industry Foundation), Yonsei University, Seoul (KR)

(72) Inventors: Heonjin Choi, Seoul (KR); Mingu Song, Seoul (KR); Junte Heo, Bucheon-si (KR)

(21) Appl. No.: 19/414,599

(22) Filed: Dec. 10, 2025

(30) Foreign Application Priority Data
Dec. 27, 2024 (KR) 10-2024-0198185
May 28, 2025 (KR) 10-2025-0069546

(51) Int. Cl. C01G 49/02

(52) U.S. Cl. CPC C01G 49/02; C01P 2002/54; C01P 2002/72; C01P 2004/04; C01P 2004/64; C01P 2004/84; C01P 2006/42

(57) ABSTRACT

Disclosed herein is a method of synthesizing core-shell iron oxide nanoparticles through continuous synthesis of the core and the shell in a single reaction chamber. The method includes: step S100 of preparing a precursor mixture for synthesizing the core-shell iron oxide nanoparticles; step S200 of synthesizing oleate complexes using the precursor mixture in a single reaction chamber; step S300 of sequentially and continuously synthesizing the core and the shell using the oleate complexes, synthesized in step S200, in the single reaction chamber, in such a manner that the amount of doping in the shell is large than that in the core; and step S400 of recovering a mixture synthesized in step S300 from the single reaction chamber, cooling the mixture, and separating the nanoparticles from the mixture.

### CROSS-REFERENCE TO RELATED APPLICATION

This application claims the benefit of Korean Patent Application Nos. KR 10-2024-0198185 filed on Dec. 27, 2024 and KR 10-2025-0069546 filed on May 28, 2025, which are hereby incorporated by reference herein in its entirety.

### BACKGROUND

### 1. Technical Field

The present invention relates to a method of synthesizing core-shell iron oxide nanoparticles. More particularly, the present invention relates to a method of synthesizing core-shell iron oxide nanoparticles through continuous synthesis of the core and the shell in a single reaction chamber.

The method of synthesizing core-shell iron oxide nanoparticles according to the present invention may be widely used in the fields of electronic engineering and material science.

The present invention was contrived from the research under the Biomedical Technology Development Project of the National Research Foundation of Korea sponsored by the Korean Ministry of Science and ICT (Task Serial No. 2022M3E5E808120212).

The present invention was also contrived from the research based on funds from the National Research Foundation of Korea sponsored by the Korean Ministry of Science and ICT (Task Serial No. 2020R1A5A101913111).

### 2. Description of the Related Art

Core-shell nanoparticles are composed of an inner core and an outer shell, and have attracted attention in various fields, including biopharmaceuticals, energy storage, and catalysts, as their physical and chemical properties can be controlled.

Magnetic nanoparticles play a crucial role in medical diagnosis, magnetic resonance imaging (MRI), and magnetic data storage devices, as their magnetic properties can be precisely controlled through the combination of core and shell materials. In particular, magnetothermal stimulation using iron oxide-based magnetic nanoparticles can induce heat even at a distance by utilizing the heat generated during the relaxation of magnetic nanoparticles in an alternating magnetic field.

Magnetic nanoparticles are known to align with a magnetic field through two different relaxation mechanisms.

The first is Neel relaxation, in which the internal magnetic spin region of the particle aligns with an external magnetic field, and the second is Brownian relaxation, in which the particle itself aligns with an external magnetic field by its physical rotation.

While Neel relaxation occurs on the order of nanoseconds, Brownian relaxation takes longer, on the order of microseconds. Accordingly, the frequency range over which particles can most efficiently generate heat varies significantly depending on which relaxation mechanism is dominant, when selecting the frequency of the external alternating magnetic field.

The dominance of the relaxation mechanism is determined by the thermal stability parameter o. In the present specification, the thermal stability parameter o is defined by Equation 1 below:

$$σ = \frac{{K}_{a n i} V}{{k}_{B} T} \qquad ( 1 )$$

where Kₐₙᵢ denotes the magnetic anisotropy constant of the magnetic nanoparticle, V denotes the volume of the magnetic nanoparticle, K_{B} denotes the Boltzmann constant, and T denotes the absolute temperature.

When the thermal stability factor o is small, the rotation of the magnetic spin layer inside the particle is relatively easy, and thus Néel relaxation, in which the internal magnetic layer is aligned in the direction of the external magnetic field, becomes dominant rather than physical rotation of the particle itself.

On the other hand, when the thermal stability factor o becomes large, more energy is required for the rotation of the inner magnetic layer, and thus Brownian relaxation, in which the particle itself rotates and aligns with the external magnetic field, operates as a main mechanism.

In particular, for magnetic particles with a certain volume, as the magnetic anisotropy constant (Kₐₙᵢ) increases, the relaxation mechanism gradually transitions from Neel relaxation to Brownian relaxation, resulting in resonance even at lower magnetic field frequencies. This, in turn, causes a significant change in the relaxation time required to align with an externally applied magnetic field.

Against this backdrop, it has been proposed that the internal magnetic anisotropy constant (Kₐₙᵢ) of magnetic iron oxide nanoparticles, which have been widely studied in the bio-field, can be effectively controlled, thereby flexibly controlling the response characteristics (e.g., resonant frequency, heat generation efficiency, etc.) to the frequency of an external alternating magnetic field.

There are three main methods for controlling the magnetic anisotropy constant of nanoparticles: (i) a method of introducing magnetocrystalline anisotropy, (ii) a method of introducing exchange anisotropy, and (iii) a method of controlling shape anisotropy.

For (i) the method of introducing magnetocrystalline anisotropy, it is known that the Kₐₙᵢ value of iron oxide-based nanoparticles varies in the range of about 10 to 200 KJ/m³ depending on the type of compound and the dopant content. For example, the most basic 2,3-iron oxide (magnetite, Fe₃O₄) generally has a magnetic anisotropy constant of about 15 to 20 KJ/m³, cobalt-iron oxide (CoFe₂O₄) in which cobalt (Co) and iron (Fe) are combined at a molar ratio of 1:2 has a high magnetic anisotropy constant in the range of about 180 to 200 KJ/m³, and manganese-iron oxide (MnFe₂O₄) in which manganese (Mn) and iron (Fe) are combined at a molar ratio of 1:2 has a low magnetic anisotropy constant in the range of about 3 to 10 KJ/m³, showing a difference of up to about 20 times in the magnetic anisotropy constant even within the same series.

However, it is understood that there is a limit to the extent to which the magnetic anisotropy constant is changed by doping. For example, in the general formula AxFe₃₋ₓO₄, where 2, 3-iron oxide (Fe₃O₄) is doped with dopant atoms A at a molar ratio of x, it has been reported that, when A=Co and x=0.1, the magnetic anisotropy constant (Kₐₙᵢ) increases to about 27 KJ/m³ (about 1.5 times that of undoped), and when x=0.3, the magnetic anisotropy constant (Kₐₙᵢ) increases to about 45 KJ/m³. That is, it has been confirmed that a change in Kₐₙᵢ due to doping is possible, but the extent of the change is not very dramatic.

For (ii) the method of introducing exchange anisotropy, exchange anisotropy is a technique for controlling Kₐₙᵢ by using the energy barrier caused by exchange coupling between different magnetic phases, and can be implemented by forming multiple phases within magnetic nanoparticles or applying surface coating or thin film structures.

Traditionally, to produce iron oxide nanoparticles with a core-shell structure, a multi-step process is required, in which the core is first synthesized and then the shell is laminated or added in a separate process.

This method should be performed in separate reaction chambers where reaction conditions (e.g., temperature, pressure, precursor concentration, etc.) for each step can be precisely controlled. Thus, this method involves process complexity and has limitations in mass productivity.

Furthermore, as the reaction environment changes between the steps in which the reaction chamber is replaced, problems may arise in that impurities are adsorbed on the core surface or an unexpected oxide layer is formed.

As a result, there is a high possibility that a non-uniform complex is formed at the boundary between the core and the shell, or that impurities are adsorbed, making it difficult to precisely control the magnetic properties of the magnetic nanoparticles.

### PRIOR ART LITERATURE

### Patent Literature

(Patent Document 1) Korean Patent No. 10-2202731 (published on Jan. 7, 2021)

### SUMMARY

A method of synthesizing core-shell iron oxide nanoparticles through continuous synthesis of the core and the shell in a single reaction chamber according to the present invention has the following objects to be achieved.

A first object to be achieved is to precisely control the core-shell structure and magnetic properties in a single reaction chamber.

A second object to be achieved is to reduce impurity incorporation and additional oxide formation during the core-shell synthesis process.

A third object to be achieved is to overcome the existing problem in which mass production is limited due to a complex, multi-step process and high costs.

The objects to be achieved by the present invention are not limited to those mentioned above, and other objects not mentioned will be clearly understood by those skilled in the art from the following description.

The present invention provides a method of synthesizing core-shell iron oxide nanoparticles through continuous synthesis of the core and the shell in a single reaction chamber, the method including: step S100 of preparing a precursor mixture for synthesizing the core-shell iron oxide nanoparticles; step S200 of synthesizing oleate complexes using the precursor mixture in a single reaction chamber; step S300 of sequentially and continuously synthesizing the core and the shell using the oleate complexes, synthesized in step S200, in the single reaction chamber, in such a manner that the amount of doping in the shell is large than that in the core; and step S400 of recovering a mixture synthesized in step S300 from the single reaction chamber, cooling the mixture, and separating the nanoparticles from the mixture.

In the present invention, in step S100, the precursor mixture may contain a mixture of different metal acetylacetonate complexes, a mixture of a polyol reducing agent and oleic acid, and oleylamine at a molar ratio of 1:(3 to 6):(3 to 6) in an organic solvent.

In the present invention, in step S100, the mixture of different metal acetylacetonate complexes may consist of a doping metal acetylacetonate complex and an iron (III) acetylacetonate complex at a molar ratio of 1:2 to 1:5.

In the present invention, in step S100, the doping metal (M) may be in the form of a divalent or trivalent ion, and may form stable complexes, which are the doping metal acetylacetonate complex (M (acac) 2 or M (acac) 3), and a metal oleate complex (M (OL) 2 or M (OL) 3) that is subsequently synthesized.

In the present invention, in step S100, the doping metal (M) may be any one of copper (Cu), nickel (Ni), cobalt (Co), aluminum (Al), or manganese (Mn).

In the present invention, in step S100, the polyol reducing agent may be a dihydric alcohol which is any one of ethylene glycol, diethylene glycol, triethylene glycol, tetraethylene glycol, glycerol, and 1,2-diols having different carbon chain lengths.

In the present invention, in step S100, the number of moles (np) of the polyol reducing agent in the mixture of the polyol reducing agent and oleic acid may be controlled using Equation 5 in consideration of the mixture consisting of the doping metal acetylacetonate complex and the iron (III) acetylacetonate complex at a molar ratio of 1:2 to 1:5.

In the present invention, in step S100, the oleic acid may be contained in an amount equal to or larger than the total amount of acetylacetonate ions (acac-) contained in the metal acetylacetonate complexes so that all the acetylacetonates are converted to oleate complexes, but may be contained in an amount satisfying Equation 7 below, in which the total number of moles of the polyol reducing agent and the oleic acid is equal to or less than twice the total number of moles of acetylacetonate ligands contained in the metal acetylacetonate complexes.

In the present invention, in step S100, the oleylamine may be contained in an amount satisfying Equation 8 below, in which the number of moles of the oleylamine is equal to or greater than the number of moles of the mixture of the polyol reducing agent and oleic acid, but is equal to or smaller than twice the total number of moles of acetylacetonate ions (acac-) contained in the mixture of different metal acetylacetonate complexes.

In the present invention, in step S100, the organic solvent may be an organic solvent that has a boiling point of 295° C. or higher and does not chemically react with an acetylacetonate-based compound during the reaction process.

In the present invention, in step S100, the organic solvent may be contained in an amount ranging from 5.0 to 15.0 L per mol of the mixture of metal acetylacetonate complexes.

In the present invention, in step S200, the precursor mixture may be introduced into the single reaction chamber and heated to a temperature of 100 to 150° C. for a predetermined period of time, so that the metal acetylacetonate complexes may be synthesized into metal oleate complexes.

In the present invention, in step S200, the precursor mixture may be heated for 1 to 6 hours.

In the present invention, in step S200, the reaction solution containing the precursor mixture may be stirred at 100 to 1,200 rpm.

In the present invention, in step S200, an inert gas may be continuously injected at a flow rate of 1 to 500 sccm. In the present invention, in step S300, the single reaction chamber containing the oleate complexes synthesized in step S200 may be heated at a predetermined heating rate to a predetermined temperature range, and maintained at the heated temperature for a predetermined time, thereby synthesizing the core while refluxing a reaction solution containing the precursor mixture.

In the present invention, in the core synthesis process of step S300, the predetermined heating rate may be 1 to 5° C./min, the predetermined temperature range may be a range of 180 to 200° C., and the predetermined time during which the heated temperature is maintained may be 30 minutes to 1 hour.

In the present invention, in the core synthesis process of step S300, an inert gas may be introduced, and when a predetermined temperature within the heating temperature range is reached, the introduction of the inert gas may be stopped.

In the present invention, in step S300, after the core synthesis process is completed, the single reaction chamber may be heated at a predetermined heating rate to a predetermined temperature range, and maintained at the heated temperature for a predetermined time, thereby synthesizing the shell on the outer surface of the core.

In the present invention, in the shell synthesis process of step S300, the predetermined heating rate may be 5 to 10° C./min, the predetermined temperature range may be a range of 280 to 300° C., and the predetermined time during which the predetermined temperature is maintained may be 30 minutes to 3 hours.

In the present invention, in step S400, the mixture synthesized in step S300 may be recovered from the single reaction chamber, cooled to room temperature, and then precipitated by adding 50 ml of ethanol or isopropyl alcohol (IPA) thereto, and a process of separating nanoparticles therefrom using centrifugation or magnetic separation may be repeated a predetermined number of times.

Meanwhile, the present invention may provide core-shell iron oxide nanoparticles. More specifically, the present invention may provide core-shell iron oxide nanoparticles produced by the method of synthesizing core-shell iron oxide nanoparticles through continuous synthesis of the core and the shell in a single reaction chamber.

The method of synthesizing core-shell iron oxide nanoparticles through continuous synthesis of the core and the shell in a single reaction chamber according to the present invention has the following effects.

First, it has the effect of performing a multi-step process, which was previously performed discontinuously in separate reaction chambers, continuously in a single reaction chamber.

Second, it has the effect of improving interface stability and the quality and reproducibility of nanoparticles.

Third, it has the effect of facilitating control of the size, shape, and magnetic properties of nanoparticles.

The effects of the present invention are not limited to those mentioned above, and other effects not mentioned will be clearly understood by those skilled in the art from the following description.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a flow chart showing a method of synthesizing core-shell iron oxide nanoparticles through continuous synthesis of the core and the shell in a single reaction chamber according to the present invention;

FIG. 2 shows the results of X-ray diffraction analysis of the crystallinity of an oleate complex depending on the heat treatment temperature;

FIGS. 3(a), 3(b), 3(c), 3(d), and 3(e) show transmission electron microscopy images of formed cores alone;

FIGS. 4(a), 4(b), 4(c), 4(d), 4(e), and 4(f) show transmission electron microscopy image of synthesized core-shell iron oxide nanoparticles;

FIGS. 5(a), 5(b), 5(c), and 5(d) show the results of analyzing the magnetic properties of synthesized core-shell iron oxide nanoparticles; and

FIGS. 6(a), 6(b), 6(c), 6(d), and 6(e) show the results of analyzing the chemical properties of synthesized core-shell iron oxide nanoparticles.

### DETAILED DESCRIPTION

Hereinafter, embodiments of the present invention will be described with reference to the accompanying drawings so that those skilled in the art to which the present invention pertains can easily carry out the present invention. As will be readily apparent to those skilled in the art to which the present invention pertains, the embodiments described below may be modified in various ways without departing from the spirit and scope of the present invention. In the accompanying drawings, identical or similar parts are denoted by the same reference numerals as much as possible.

The terminology used herein is only for the purpose of describing specific embodiments and is not intended to limit the present invention. As used herein, singular forms also include plural forms, unless the context clearly dictates otherwise.

As used herein, the term “including” or “comprising” specifies the presence of stated features, regions, integers, steps, operations, elements, and/or components, but do not preclude the presence or addition of other features, regions, integers, steps, operations, elements, components and/or groups thereof.

All terms used herein, including technical and scientific terms, have the same meaning as commonly understood by those skilled in the art to which the present invention pertains. The terms defined in dictionaries should be further interpreted as having meanings identical to the relevant technical literature and the present invention, and are not to be construed as having meanings that are ideal or excessively formal, unless otherwise defined.

As used herein, expressions related to direction, such as front/back/left/right, up/down, and longitudinal/transverse, may be interpreted with reference to the directions disclosed in the drawings.

In order to solve the above-described problems, the present invention proposes a method capable of continuously synthesizing a core and a shell in a single reaction chamber (one-pot) instead of a conventional process of synthesizing the core and the shell discontinuously in separate reaction chambers.

In particular, the present invention has the feature of sequentially and continuously synthesizing a “low-doped core” and a “highly doped shell” separately in the same reaction chamber by the stepwise use of the difference in decomposition temperature of precursors doped on iron oxide.

Both core and shell materials are introduced into a single reaction chamber (reactor), and the reaction temperature is increased stepwise so that the doping reaction is initiated at the desired point in time by utilizing the difference in decomposition temperatures between precursors. This ensures that the doping amount remains relatively small in the core region, while at subsequent higher temperatures, the doping amount significantly increases in the shell region.

Thereby, not only the change in the magnetic anisotropy constant achieved by controlling the doping amount, but also the change in the magnetic anisotropy constant through exchange anisotropy occurring at the core-shell interface exists, so that control of the magnetic anisotropy constant over a wider range may be expected.

As a result, magnetic nanoparticles that match the frequency band required for specific bio- or medical applications may be easily designed and realized.

In addition, the process of producing core-shell nanoparticle according to the present invention has a technical feature in that it performs the synthesis of a core material and the shell synthesized thereon in a continuous and sequential manner in a single reaction chamber (one-pot), thereby effectively prevents the incorporation of impurities that is likely to occur at the process transition stage, and excessive synthesis of oxidized species.

More specifically, in conventional core-shell synthesis, after completing the core production step, the reaction solution or sample is transferred to a separate reaction vessel, and then a procedure is required to grow the shell by newly creating temperature conditions, atmosphere (e.g., inert gas, reducing gas, etc.), and precursor concentration.

This two-step (or multi-step) process is prone to problems such as residual impurities or the formation of oxide bonding layers at the interface between the core and the shell, and has a disadvantage in that reproducibility is reduced due to contact with residual substances inside the reactor or external air.

In contrast, in the present invention, a continuous process from the core synthesis step to the shell formation step is performed by sequentially changing the precursors and reaction conditions (temperature, pressure, solvent environment, reduction/oxidation atmosphere, etc.) required within a single reactor.

In this case, even after the precursor required for core synthesis is consumed, the residual reaction environment is maintained, and the shell material grows without the introduction of additional precursors or catalysts.

In this way, there is no need to transfer the reaction mixture in an intermediate step, and thus the possibility of oxidation from outside air or incorporation of fine impurities from the surface of the process equipment is significantly reduced.

In particular, in order to maintain the microstructural characteristics required at the core-shell interface, oxidation or contamination during the process should be minimized so that the crystallinity of the core surface is not damaged. The continuous synthesis process using a single reaction chamber according to the present invention provides optimal conditions capable of stably maintaining the interface characteristics without damaging them.

For example, since the shell precursor comes into contact and reacts with the surface of the core surface already produced in the core synthesis step, the possibility that an unnecessary interfacial intermediate layer (oxide layer or contaminant layer) is formed is reduced, and as a result, the bonding between the core and shell exhibits a uniform and strong structure.

That is, since the reaction temperature, the presence or absence of a reducing agent (or an oxidizing agent), pH, solvent composition, etc. may be consistently controlled, core recrystallization or excessive oxidation due to external factors may be suppressed, and a highly crystalline (core-shell) structure may be synthesized reproducibly.

The method of the present invention is not limited to the synthesis of magnetic nanoparticles, but may also be applied to the synthesis of semiconductor luminescent nanoparticles such as quantum dots. These characteristics may serve as a foundational technology for enhancing the utilization of core-shell nanoparticles in various industrial fields, including medicine, energy, and electronic devices.

The present invention will be described below with reference to the drawings. For reference, the shapes and sizes of components in the drawings may be exaggerated to illustrate the features of the present invention. In such cases, it is preferable to interpret them in light of the overall intent of the present specification.

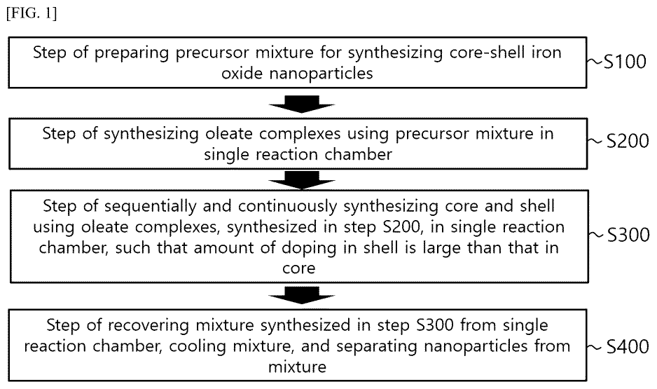

FIG. 1 is a flow chart showing a method of synthesizing core-shell iron oxide nanoparticles through continuous synthesis of the core and the shell in a single reaction chamber according to the present invention.

The present invention provides a method of synthesizing core-shell iron oxide nanoparticles through continuous synthesis of the core and the shell in a single reaction chamber, the method step S100 of preparing a precursor mixture for including: synthesizing the core-shell iron oxide nanoparticles; step S200 of synthesizing oleate complexes using the precursor mixture in a single reaction chamber; step S300 of sequentially and continuously synthesizing the core and the shell using the oleate complexes, synthesized in step S200, in the single reaction chamber, in such a manner that the amount of doping in the shell is large than that in the core; and step S400 of recovering a mixture synthesized in step S300 from the single reaction chamber, cooling the mixture, and separating the nanoparticles from the mixture.

Hereinafter, step S100 will be described.

Step S100 according to the present invention is a step of preparing a precursor mixture for synthesizing core-shell iron oxide nanoparticles.

In the present invention, in step S100, the precursor mixture may contain a mixture of different metal acetylacetonate complexes, a mixture of a polyol reducing agent and oleic acid, and oleylamine at a molar ratio of 1:(3 to 6):(3 to 6) in an organic solvent.

In one embodiment, when the amount of the “mixture of different metal acetylacetonate complexes” is set to 3.0 mol, the mixture of the polyol reducing agent and oleic acid is added in an amount of about 9.0 to 18.0 mol, and oleylamine is added in an amount of about 9.0 to 18.0 mol. These raw materials are mixed together in a chemically stable organic solvent, thereby preparing the precursor mixture, so that nanoparticles are synthesized therefrom in the subsequent reaction process.

In step S100, the mixture of different metal acetylacetonate complexes may consist of a doping metal acetylacetonate complex and an iron (III) acetylacetonate complex at a molar ratio of 1:2 to 1:5.

The mixture of different metal acetylacetonate complexes used in the present invention is mainly prepared by mixing iron (III) acetylacetonate (Fe(acac)₃, iron (III) acetylacetonate) and a metal acetylacetonate complex for doping. In this case, in order to maintain the characteristics as an iron oxide-based compound, the content of iron (III) acetylacetonate in the mixture is preferably such that the molar ratio of the doping metal acetylacetonate complex to the iron (III) acetylacetonate complex is 1:2 to 1:5.

If the molar ratio is less than 1:2, the structure mainly composed of iron oxide will not be sufficiently synthesized during the synthesis process, so that some oxides composed only of doping metal may be formed (cobalt oxide—Co₃O₄, manganese oxide—Mn₃O⁴, etc.), and thus it may be difficult to stably realize the desired magnetic properties (e.g., magnetic anisotropy constant, magnetic susceptibility, etc.).

If the molar ratio exceeds 1:5, i.e., if the doping complex is insufficient, a problem may arise in that a sufficient doping element is not introduced into the shell, and thus the doping difference between the core and the shell is insignificant and unclear.

In step S100, the doping metal (M) may be in the form of a divalent or trivalent ion, and may form stable complexes, which are acetylacetonate complexes (M(acac)₂ or M(acac)₃), and metal oleate complexes (M(OL)₂ or M(OL)₃) that are subsequently synthesized.

In step S100, the doping metal (M) may be any one of copper (Cu), nickel (Ni), cobalt (Co), aluminum (Al), or manganese (Mn).

The doping metal (M) is generally in the form of a divalent or trivalent ion, and may form stable complexes, which are acetylacetonate complexes (M(acac)₂ or M(acac)₃), and metal oleate complexes (M(OL)₂ or M(OL)₃) that are subsequently synthesized.

Examples of doping metals that may be used in the present invention include copper (Cu), nickel (Ni), cobalt (Co), aluminum (Al), manganese (Mn), etc., which impart a desired doping effect during the reaction process by synthesizing M(acac)ₓ and M(OL)ₓ.

In the case of acetylacetonate complexes synthesized using monovalent metal ions, the monovalent metal ions are a factor that destabilizes the spinel structure of iron oxide. Thus, the metal ions are preferably in the form of divalent or trivalent ions.

In step S100, the polyol reducing agent may be a dihydric alcohol which is any one of ethylene glycol, diethylene glycol, triethylene glycol, tetraethylene glycol, glycerol, and 1,2-diols having different carbon chain lengths.

In the mixture of the polyol reducing agent and oleic acid in step S100, the polyol reducing agent and oleic acid are essential components for the formation of metal oleate complexes (M(OL)₂ or M(OL)₃) while serving as a surfactant.

In this case, the number of moles of the mixture of the polyol reducing agent and oleic acid may be equal to or at most twice the total number of moles of acetylacetonate ligands contained in the mixture of different metal acetylacetonate complexes.

That is, the number of moles may be expressed as shown in Equation 2 below:

$${n}_{2} + {n}_{3} \leq {n}_{p} + {n}_{0} \leq 2 ( {n}_{2} + {n}_{3} ) \qquad ( 2 )$$

denotes the number of moles of the divalent ion acetylacetonate complex in the mixture of different metal acetylacetonate complexes, n₃ denotes the number of moles of the trivalent ion acetylacetonate complex in the mixture, nₚ denotes the number of moles of the polyol reducing agent in the mixture of the polyol reducing agent and oleic acid, and nₒ denotes the number of moles of oleic acid.

If the number of moles (nₚ+nₒ) of the mixture of the polyol reducing agent and oleic acid exceeds twice the total number of moles (n₂+n₃) of acetylacetonate ligands contained in the mixture of different metal acetylacetonate complexes, problems may arise in that particle growth is excessively suppressed, resulting in a decrease in crystallinity, and amorphous or polycrystalline particles are formed.

Conversely, the number of moles (nₚ+nₒ) of the mixture of the polyol reducing agent and oleic acid is smaller than the total number of moles (n₂+n₃) of acetylacetonate ligands contained in the mixture of different metal acetylacetonate complexes, a problem may arise in that the metal oleate complexes (M(OL)₂ or M(OL)₃) are not completely formed, making it stable synthesis difficult.

When the mixture of different metal acetylacetonate complexes is present together with oleic acid, a reaction of forming metal oleate complexes (M(OL)₂ or M(OL)₃) proceeds. During this process, the polyol reducing agent enters the reaction system under a competitive coordination environment competitive with oleic acid.

Therefore, the number of moles of the polyol reducing agent should be in relative balance with the number of moles of oleic acid depending on the degree of reduction of different metal acetylacetonate complexes.

Additionally, the polyol, when interacting with metal ions, serves to cleave bonds through hemolytic cleavage and reduce the metal ion by donating an electron to the metal ion. This reaction is expressed by Equation 3 below:

$${{M}^{3 +} ( acac )}_{3} + 2 O L - COOH + polyol \to \qquad ( 3 )$$

$${M}^{3 +} ( polyol ) {( O L )}_{2} + 3 H acac \to$$

$${{M}^{2 +} ( O L )}_{2} + 3 H acac + b P \to$$

In addition, the reaction in which a divalent ion is reduced to a monovalent ion requires a higher temperature (>210° C.) than the reaction in which a trivalent ion is reduced to a divalent ion, and thus this reaction may be ignored in ligand substitution reactions.

When a doping metal acetylacetonate complex is added, it is important to maintain the ionic ratio of the material to maintain the crystal structure of iron 2,3-oxide (Fe₃O₄). Fe₃O₄ is a mixed-valence iron oxide with an average ionic valence of +2.67, which corresponds to a composition in which the ratio between divalent ions (Fe²⁺) and trivalent ions (Fe³⁺) is 1:2. Accordingly, in the present invention, the average ionic valence of the mixture of the doping metal and the iron(III) acetylacetonate complex is maintained, excellent crystallinity may be maintained even when the complex is doped.

When the doping metal acetylacetonate complex is a divalent metal acetylacetonate complex (M(acac)₂), the total average ionic valence of the mixture of different metal acetylacetonate complexes varies depending on the molar ratio with the iron(III) acetylacetonate (Fe(acac)₃).

The distribution of the total average ionic valence of the mixture of different metal acetylacetonate complexes may be in the range of +2.83 (1:5, minimum doping) to +2.66 (1:2, maximum doping). This has a slight deviation from the ideal ionic ratio of Fe₃O₄(Fe²⁺:Fe³⁺=1:2, average ionic valence: +2.67), and in this case, a certain amount of a reducing agent is additionally required to maintain the stability of the crystal structure and the ionic ratio.

In this case, when the molar ratio of the doping metal acetylacetonate complex to the iron(III) acetylacetonate complex is 1:2 (when doping is at its maximum), the ionic ratio of Fe₃O₄ may be maintained without adding a polyol reducing agent because the ionic ratio is already satisfied at 1:2.

For example, when the molar ratio of the doping metal acetylacetonate complex to the iron (III) complex is 1:2, the target ion ratio is achieved without adding a reducing agent because the Fe²⁺ ions supplied from the doping metal are sufficient.

On the other hand, when the molar ratio is 1:5, the number of moles corresponding to about ⅕ of the total iron(III) complex compound should be reduced, and the ionic composition In this case is 1 mol (doped M²⁺): 1 mol (Fe³⁺ to be reduced): 4 mol (Fe³⁺ to be unreduced). When the amount of the mixture of the polyol reducing agent and oleic acid is derived based on the total number of ligands, there are 2 acac ligands in 1 mol of doping metal and 15 acac ligands in 5 mol of iron(III) complex compound, and thus the total number of ligands is 17 mol. Since only 1 mol of the 17 mol is to be reduced, the ratio of the polyol reducing agent to the mixture of the polyol reducing agent and oleic acid should be 1/17.

For example, when the mixture of the divalent doping metal acetylacetonate complex and the iron(III) acetylacetonate complex is set to a total of 3.0 mol, the total number of acetylacetonate ligands is formed between 8.0 mol (1:2 doping) and 17.0 mol (1:5 doping) depending on the doping ratio. In this case, the polyol reducing agent is added an amount within the range of 0 to 1.0 mol, which is calculated according to the number of Fe³⁺ ions to be reduced.

In addition, oleylamine may be added in the same mole number (8.0 to 17.0 moles) as the mixture of the polyol reducing agent and oleic acid in order to stabilize the reaction and control particle dispersion.

Meanwhile, when the doping metal acetylacetonate complex is a trivalent ionic metal complex (M(acac)₃), the total average ionic valence is constant at +3 regardless of the ratio of the mixture of different metal acetylacetonate complexes.

Therefore, considering that the mixture of different metal acetylacetonate complexes is to be reduced, the reducing agent is added so that the ratio between divalent ions (M²⁺, Fe²⁺) and trivalent ions (M³⁺, Fe³⁺) becomes 1:2. Accordingly, the molar ratio of the mixture of the polyol reducing agent and oleic acid becomes 1:8.

In one embodiment, when the mixture of metal acetylacetonate complexes composed of only trivalent ions is set to 3.0 mol, the mixture of the polyol reducing agent and the oleic acid may be set to 9.0 to 18.0 mol. In this case, the polyol reducing agent is added in an amount of about 1 to 2 mol, and oleylamine is added in an amount of 9.0 to 18.0 mol, which is the same as the amount of the mixture of the polyol reducing agent and the oleic acid.

Regardless of the number of moles of the doping metal acetylacetonate complex, the relevant content may be summarized as follows.
n₂: the number of moles of the divalent ion acetylacetonate complex
n₃: the number of moles of the trivalent ion acetylacetonate complex (Fe(acac)₃, etc.)
nₚ: the number of the moles of the polyol reducing agent
nₒ: the number of moles of oleic acid
r: the number of moles of trivalent ions to be reduced=the number of moles of the polyol reducing agent (nₚ)

In this case, the total number of ions after reduction is (n₂+n₃), and the total charge of the ions is 2n₂+3(n₃−r)+2r=2n₂+3n₃−r.

That is, in order to make the total average ionic valence, which is the target value, 8/3 (=2.67), the following Equations 4 and 5 should be satisfied, and ultimately, the polyol reducing agent is added in an amount that satisfies Equation 5.

$$\frac{2 {n}_{2} - 3 {n}_{3} - r}{{n}_{2} + {n}_{3}} = \frac{8}{3} \qquad ( 4 )$$

$$r = {n}_{p} = \frac{{n}_{3} - 2 {n}_{2}}{3} \qquad ( 5 )$$

In summary, in step S100, in the mixture of the polyol reducing agent and oleic acid (where the number of moles of the polyol reducing agent is defined as nₚ and the number of moles of the oleic acid is defined as nₒ), the number of moles (nₚ) of the polyol reducing agent may be controlled to satisfy nₚ=(n₃−2n₂)/3 according to Equation 5 depending on the number of moles (n₂) of the divalent ion acetylacetonate complex and the number of moles (n₃) of the trivalent ion acetylacetonate complex in the mixture consisting of the doping metal acetylacetonate complex and the iron(III) acetylacetonate complex at a molar ratio of 1:2 to 1:5.

Therefore, referring to Equations 2 and 5, the number of moles (nₒ) of oleic acid when considering the number of moles of divalent ions and trivalent ions in the mixture of different metal acetylacetonate complexes is as shown in Equation 6 below:

$$\frac{5 {n}_{2} + 2 {n}_{3}}{3} \leq {n}_{0} \leq \frac{7 {n}_{2} + 5 {n}_{3}}{3} \qquad ( 6 )$$

The purpose of the present invention is to synthesize 2,3-iron oxide (Fe₃O₄) using polyol as a reducing agent.

As used herein, the term “polyol” refers to dihydric alcohols, including ethylene glycol, diethylene glycol, triethylene glycol, tetraethylene glycol, glycerol, etc., and 1,2-diols (1,2-octanediol, 1,2-decanediol, etc.) having different carbon chain lengths.

In the literature, some reports have suggested that oleic acid can act as a reducing agent. However, oleic acid has a relatively weak reducing ability compared to a polyol. Therefore, it has been confirmed that, when polyol is used as a reducing agent to synthesize a desired amount of Fe²⁺, high-quality nanoparticles compared to those when using oleic acid as both a reducing agent and a reaction catalyst are synthesized.

Iron(III) acetylacetonate (Fe(acac)₃) is composed entirely of iron (Fe³⁺) in a trivalent ion state, but some of the Fe³⁺ ions should be reduced to Fe²⁺ by polyol so that the Fe₃O₄(FeO·Fe₂O₃) structure is synthesized.

2,3-Iron oxide (Fe₃O₄) is composed of divalent ions (Fe²⁺) and trivalent ions (Fe³⁺) at a molar ratio of 1:2.

If polyol is excessively added, most of the iron(III) ions are reduced to divalent ions (hereinafter referred to as “Fe²⁺”) during the reaction process, and a completely reduced rock-salt phase such as FeO may be obtained. Since FeO has an antiferromagnetic structure and a total magnetization of 0, it is disadvantageous for achieving magnetic properties. On the other hand, if polyol is not added at all, there is a high possibility that the iron(III) ions will not be reduced and will crystallize in the form of γ-Fe₂O₃(maghemite) or α-Fe₂O₃ (hematite).

This is because the balance of Fe²⁺/Fe³⁺ (1:2) required in the present invention is not satisfied, and as a result, it may be difficult to synthesize the desired 2,3-iron oxide (Fe₃O₄).

Meanwhile, each molecule of iron(III) acetylacetonate (Fe(acac)₃) contains three acetylacetone (acac−) ligands, and thus all the iron ions are maintained in a Fe³⁺ state.

In the present invention, some of the acac⁻ ligands should be substituted/reduced by polyol to synthesize Fe²⁺.

In the present invention, oleic acid is added in a sufficient amount to form metal-oleate complexes.

It is most desirable to set the amount of polyol added to be about ⅓ of the amount of oleic acid added.

This is because about ⅓ of the total iron ions should be reduced to Fe²⁺ during Fe₃O₄ synthesis. If this ratio is satisfied, the reduction ratio deviates from the molar ratio between the divalent ion (Fe²⁺) and the trivalent ion (Fe³⁺) of 2,3-iron oxide (Fe₃O₄), increasing the possibility of crystallization in the form of γ-Fe₂O₃(maghemite) or α-Fe₂O₃(hematite).

If the amount of polyol added is larger than the upper limit of the above range, Fe(III) will be excessively reduced and thus phases such as FeO will be synthesized, and if the amount is smaller than the lower limit of the above range, the ratio of Fe²⁺ will be insufficient, and thus and there will be a high tendency for Fe₂O₃-based nanoparticles to be synthesized primarily.

By using the polyol in an amount within the optimal range presented in the present invention, it is possible to synthesize an Fe₃O₄ phase in which Fe²⁺ and Fe³⁺ stably exist at a ratio of 1:2.

In order to perform a high-temperature (300° C. or higher) reaction in the polyol process, a compound is required, which has a sufficiently high boiling point, may be stably maintained in a liquid state even at high temperatures (without partial decomposition or evaporation if necessary), and may also act as a reducing agent or a solvent.

As polyols satisfying these conditions, the following two types (1) and (2) may be presented.
(1) Ethylene glycol chain extenders, for example:
1-1) Triethylene glycol (TEG, bp: about 285° C.)
1-2) Tetraethylene glycol (TEG, bp: about 314° C. (1 atm))
1-3) Pentaethylene glycol (PEG(5), bp: about 327° C. (1 atm))
(2) Diols having 12 or more carbon atoms (dodecane) among 1,2-alkanediols, for example:
2-1) 1,2-Dodecanediol (C₁₂ diol, bp: about 300 to 305° C.)
2-2) 1,2-Tetradecanediol (C14 diol, bp: about 320° C.)
2-3) 1,2-Hexadecanediol (C₁₆ diol, bp: about 330 to 335° C.)
2-4) 1,2-Octadecanediol (C₁₈ diol, bp: about 350 to 360° C.).

As the chain length increases, viscosity increases and reactivity decreases. Thus, it is preferable to use a 1,2-alkanediol having less than 20 carbon atoms as the polyol.

In step S100, the oleic acid may be contained in an amount equal to or larger than the total amount of acetylacetonate ions (acac⁻) contained in the metal acetylacetonate complex so that all the acetylacetonates are converted to oleate complexes, and may be provided to satisfy Equation 7 so that the number of moles of the oleic acid is at most twice the number of moles of acetylacetonate ligands contained in the metal acetylacetonate complexes.

$$( {n}_{p} + {n}_{0} ) / ( 2 {n}_{2} + 3 {n}_{3} ) \leq 2 \qquad ( 7 )$$

where (nₚ+nₒ) denotes the number of moles of the mixture of the polyol reducing agent and oleic acid, and (2n₂+3n₃) denotes the number of moles of the acac ligands, which are acetylacetonate anions.

Oleic acid is an essential reactant for converting a metal acetylacetonate compound (M^{x+}(acac)ₓ) to metal oleate complexes (M^{x+}(OL)ₓ) (x=2 or 3).

To ensure that all acetylacetonates are converted to oleate complexes, oleic acid should generally be added in an amount at least equal to the total amount of acetylacetone ions (acac−) contained in the metal acetylacetonate compound. Considering the reaction rate, adding a slightly larger amount than the total amount of acetylacetone ions (acac−) is advantageous for reaction progress.

However, excessive supply of oleic acid may cause difficulty in controlling the reaction rate due to the excessive presence of ligands in the reaction solution, or may cause process problems such as aggregation between particles or decreased crystallinity during the nanoparticle synthesis step due to the production of unnecessary byproducts (metal-fat complexes). Therefore, it is preferred that the amount of oleic acid added not exceed twice the amount of all acetylacetonates contained in the mixtures of metal acetylacetonates.

In step S100, the oleylamine may be contained in an amount equal to or larger than the number of moles of the mixture of the polyol reducing agent and oleic acid, but may be contained in an amount not greater than twice the total amount of acetylacetonate ions (acac⁻) contained in the mixture of different metal acetylacetonate complexes, that is, in an amount not greater than twice the number of moles of the mixture of the polyol reducing agent and oleic acid.

This condition may be expressed as follows:

nₚ+nₒ≤number of moles of oleylamine≤2*(2n₂+3n₃)

Here, if the number of moles of oleylamine is expressed as nₒₐ, it may be expressed as Equation 8 below:

$${n}_{p} + {n}_{0} \leq {n}_{o a} \leq 2 ( 2 {n}_{2} + 3 {n}_{3} ) \qquad ( 8 )$$

Oleylamine acts as a catalyst that accelerates or activates the reaction between metal oleate complexes (M(OL)ₓ) that are synthesized in the synthetic process of the present invention. Therefore, it is generally recommended to add oleylamine in an amount similar to the number of moles of oleic acid to achieve a balance between the two.

If the content of oleylamine is excessively low, the reaction process may be only partially catalyzed, increasing the size distribution (polydispersity) of the synthesized nanoparticles and making it difficult to control the crystallinity or shape. On the other hand, if oleylamine is present in excess, only certain localized regions may be excessively activated, increasing the likelihood that crystal growth will proceed unevenly or that the produced nanoparticles will be biased toward a cubic or trigonal pyramidal shape rather than a spherical shape.

In addition, in the present invention, it has been confirmed that it is preferable to add oleylamine in an amount equal to or more than the number of moles of oleic acid, but in an amount not exceeding twice the total amount of acetylacetonate ions (acac−) contained in the mixture of metal acetylacetonates. By observing such conditions, the acid-base balance within the reactants may be maintained and excessive reaction deviation may be prevented.

In step S100, the organic solvent may be an organic solvent that has a boiling point of 295° C. or higher and does not chemically react with an acetylacetonate-based compound during the reaction process.

In the present invention, it is preferable to use an organic solvent that has a boiling point of 295° C. or higher and does not chemically react with an acetylacetonate-based compound during the reaction process.

For example, benzyl ether with a boiling point of about 298 to 300° C., 1-octadecene with a boiling point of about 315° C., trioctylamine with a boiling point of about 365° C., trioctylphosphine with a boiling point of about 370° C., hexadecane with a boiling point of about 287° C., or dodecylbenzene with a boiling point of about 360° C. may be used.

In step S100, the organic solvent may be contained in an amount ranging from 5.0 to 15.0 L per mol of the mixture of metal acetylacetonate complexes.

In the present invention, it is preferable to set the amount of the organic solvent in the range of 5.0 to 15.0 L per mol of the mixture of metal acetylacetonate complexes.

This directly affects the concentration of the reaction solution (concentration of metal acetylacetonates and metal oleate complexes), which in turn changes the chemical potential energy, which can change whether the nanoparticle synthesis reaction is interface-controlled or diffusion-controlled.

If the content of the organic solvent is less than 5.0 L per mol of the mixture of metal acetylacetonate complexes, interfacial control will dominate, increasing nucleation and growth rates and potentially leading to the synthesis of larger particles. Consequently, the average particle size tends to increase. In addition, the concentration of synthesized nanoparticles locally becomes very high, making it difficult to overcome the interfacial energy and increasing the likelihood of agglomeration, precipitation, or clustering.

When the content of the organic solvent exceeds 15.0 L per mol of the mixture of metal acetylacetonate complexes, diffusion will dominates, limiting the supply of precursors necessary for particle growth. Consequently, the average particle size tends to decrease. Additionally, the particle size becomes excessively small, and thus the proportion of the spin canting layer synthesized on the surface increases.

For example, when the reactions were carried out under the same conditions with ratios of 1 mol:5.0 L solvent, 1 mol:7.5 L solvent, and 1 mol:10 L solvent using iron(III) acetylacetonate (Fe(acac)₃), the average sizes of the synthesized nanoparticles were about 7.9 nm, 6.5 nm, and 5.9 nm, respectively, suggesting that the particle size gradually decreased as the amount of the solvent increased.

On the other hand, if the amount of the solvent is excessively small, the concentration of synthesized nanoparticles locally increases significantly, making it difficult to overcome interfacial energy and increasing the likelihood of agglomeration, precipitation, or clustering. Conversely, if the amount of the solvent is excessively large, the particle size becomes excessively small, increasing the proportion of the spin canting layer synthesized on the surface. This layer is typically about 1.4 nm thick, but it does not exhibit magnetism and its magnetic moment is pinned, which causes a problem in that the saturation magnetization is significantly reduced. Accordingly, in the present invention, using the organic solvent in an amount ranging from about 5.0 to 15.0 L per mol of the mixtures of metal acetylacetonate complexes is suitable for stably performing the entire nanoparticle synthesis process. This is considered to be the optimal condition for uniformly maintaining the crystallinity, size distribution, and final magnetic properties of nanoparticles.

Hereinafter, step S200 will be described.

Step S200 according to the present invention a step of synthesizing oleate complexes using the precursor mixture in a single reaction chamber.

In step S200, the precursor mixture may be introduced into the single reaction chamber and heated to a temperature of 100 to 150° C. for a predetermined period of time, so that the metal acetylacetonate complexes may be synthesized into metal oleate complexes.

In step S200, the precursor mixture (containing metal acetylacetonate complexes, oleic acid, oleylamine, 1,2-polyol, etc.) is introduced into a reaction chamber (e.g., a flask), and then heated to a temperature of about 100 to 150° C., and maintained at that temperature for 1 to 3 hours, thereby forming metal-oleate complexes. This process is a key preliminary step for the nanoparticle synthesis process that is performed in the subsequent step (step S300), and aims to effectively convert metal acetylacetonate into metal-oleic acid through ligand exchange reaction.

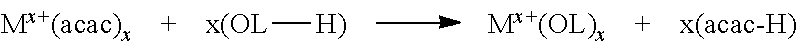

In step S200, if the temperature is below 100° C., the produced acetylacetone and residual moisture are not sufficiently removed, and thus there is a high possibility that heterogeneous elements will accumulate within the reaction solution. For this reason, the ligand exchange reaction may become incomplete or slow down, so that the desired metal-oleate complexes may not be stably synthesized.

If the temperature is above 150° C., some metal acetylacetonates (or already synthesized metal-oleate complexes) begin to decompose and crystallize prematurely under the influence of oleylamine before the ligand exchange reaction is complete. In this case, the difference in nucleation timing causes overlapping nuclei, increasing the particle size distribution and making it difficult to implement a multistep reaction where the core and the shell are distinct.

In step S200, the heating time is preferably 1 to 6 hours.

In step S200, the reaction solution may be stirred at a speed ranging from 100 to 1,200 rpm.

To maintain uniform mixing in the reaction solution, stirring at a speed of about 100 to 1,200 rpm is preferable. If the stirring speed is excessively low, contact between the reactants will be insufficient, and conversely, if it the stirring speed is excessively high, problems such as gas incorporation or local overheating at the solution surface may occur. Thus, caution is required.

In step S200, an inert gas may be continuously injected at a flow rate of 1 to 500 sccm.

An inert gas, such as nitrogen (N₂) or argon (Ar), is continuously injected at a flow rate of about 1 to 500 sccm to maintain the inside of the reaction system in a nearly oxygen-free atmosphere. This is to prevent the metal acetylacetonate complexes and the metal-oleate complexes from being oxidized or decomposed by oxygen or moisture.

If the flow rate exceeds 500 sccm, local cooling within the reaction chamber and simultaneous solvent vaporization may deteriorate reaction stability. Thus, it is desirable to maintain the flow rate at 500 sccm or less. Furthermore, the use of reactive gases such as oxygen (O₂) or hydrogen (H₂) may induce oxidation-reduction reactions of the solvent or ligand, and thus the selection of an inert gas is preferred in this field.

For reference, the reason why step S200 is important is because the rate at which the metal-oleate complexes decompose in a temperature-dependent manner for nanoparticle synthesis varies depending on the type of metal.

Metal acetylacetonate complexes and metal-oleate complexes have different thermal decomposition temperatures and decomposition rates depending on the type of metal (M).

In particular, a point of importance in the present invention is that the decomposition temperature of the metal-oleate complexes often has a trend that is reversed from the decomposition temperature of the metal acetylacetonate.

For example, the complete decomposition temperature of metal-acetylacetonate complexes (hereinafter referred to as “acetylacetonate”) is manganese acetylacetonate (242° C.)>iron acetylacetonate (192° C.)>cobalt acetylacetonate (180° C.), and the complete decomposition temperature of metal-oleate complexes (hereinafter referred to as “oleate”) (complete decomposition temperature means the temperature at which 99% or more of the reactants are decomposed) is manganese oleate (319° C.)<iron oleate (348° C.)<cobalt oleate (353° C.).

For example, in the case of manganese (Mn), metal-acetylacetonate (Mn(acac)₂) begins to decompose at relatively high temperatures (about 242° C.), but metal-oleate (Mn(OL)₂) does not completely decompose until it reaches 319° C., and may exhibit temperature characteristics that are opposite to those of iron (Fe) or cobalt (Co).

Since the decomposition temperature and reaction tendency vary depending on the types of metal and complex as described above, it is important in the present invention to maintain step S200 for a sufficient time (at least 1 hour) under low-temperature conditions (100 to 150° C.) to ensure that the metal-acetylacetonate is completely converted to the metal-oleate. If step S200 is maintained for less than 1 hour, the acetylacetonate and oleate will decompose simultaneously, making it difficult to achieve the desired selective doping, and also limiting the control of the core-shell composition using the step-by-step decomposition characteristics.

Furthermore, when step S200 is maintained for a long time, faithful conversion of the precursor is possible, so that the reaction efficiency may be increased, but even when the reaction chamber is continuously stirred, the local temperature near the heating source is higher, potentially leading to premature nucleus formation. This can lead to defects in the final nanoparticles or reduced particle size uniformity. Thus, it is not preferable to extend step S200. Indeed, after about 6 hours at which acetylacetone vapor no longer occurs, most of the reactants have already been converted to oleate, and thus there is little practical benefit in maintaining step S200 for more than 6 hours. Therefore, in the present invention, the reaction for conversion to metal-oleate is performed for a time ranging from 1 hour to 6 hours, thereby providing a foundation for selectively controlling the core-shell composition and enables accurate synthesis of the desired core/shell structure in the subsequent step (step S300).

The core/shell synthesis reaction to be performed in step S300 utilizes the different decomposition behaviors of the metal oleate complexes for each metal. If the exact ligand exchange reaction does not occur in step S200, the core and the shell may not be synthesized in the intended order in the reaction temperature range in the subsequent step, which may result in particle non-uniformity.

Hereinafter, step S300 will be described. Step S300 according to the present invention is a step of sequentially and continuously synthesizing the core and the shell using the oleate complexes, synthesized in step S200, in the single reaction chamber, in such a manner that the amount of doping in the shell is large than that in the core

The following describes the core synthesis process in step S300 in more detail.

In step S300, the single reaction chamber containing the oleate complexes synthesized in step S200 may be heated at a predetermined heating rate to a predetermined temperature range, and maintained at the heated temperature for a predetermined time, thereby synthesizing the core while refluxing the reaction solution containing the precursor mixture.

In the core synthesis process in step S300, the predetermined heating rate may be 1 to 5° C./min, the predetermined temperature range may be a range of 180 to 200° C., and the predetermined time during which the heated temperature is maintained may be 30 minutes to 1 hour.

In the core synthesis process in step S300, an inert gas may be introduced, and when a predetermined temperature within the heating temperature range is reached, the introduction of the inert gas may be stopped.

In the present invention, the refluxing refers to the process in which the entire solution containing the precursor for forming the shell is boiled to evaporate the solvent, and then cooled so that the solvent is returned to the reaction chamber. Here, the material that is refluxed refers to the reaction solution containing the precursor.

In the present invention, the metal-oleate complexes are synthesized using the precursor mixture (containing metal acetylacetonate complexes, metal-oleate intermediates, oleic acid, oleylamine, polyol, etc.) prepared in step S200, and then the reaction chamber is heated to 180 to 200° C. at a heating rate of about 1 to 5° C./min and maintained for 30 minutes to 1 hour while being refluxed, thereby synthesizing the core.

In this step, core synthesis may be carried out at a relatively low temperature (180 to 200° C.), thereby increasing the flexibility of the reaction process, reducing excessive energy consumption, and enhancing reaction safety.

In a conventional art, a multi-step process has been commonly employed, in which cores are synthesized at high temperatures (300° C. or higher), and then nanoparticles are separated from the cores and shells are synthesized in a separate reaction chamber. This is because nanoparticles synthesized at high temperatures are known to have superior crystallinity and thus superior magnetic properties (e.g., saturation magnetization) compared to those synthesized at lower temperatures.

However, this method using the separate chamber method had problems such as complicated reaction processes (requiring separate reactors for core and shell synthesis, and sample transfer procedure), possibility of impurity incorporation and oxidation (contact with external air during intermediate transfer process), and increased process cost and time (equipment cleaning, temperature reset, etc.).

The present invention has been designed to sequentially synthesize the core and the shell in a single same reactor (one-pot) in order to solve the problems of the above-mentioned conventional art.

In particular, after the core is produced at a low temperature (180 to 200° C.), the temperature is increased to a maximum of 300° C. in the subsequent shell synthesis step so that the effect of high-temperature heat treatment on the core may be obtained, thereby preventing the problem of crystallinity deterioration that may occur in the low-temperature process.

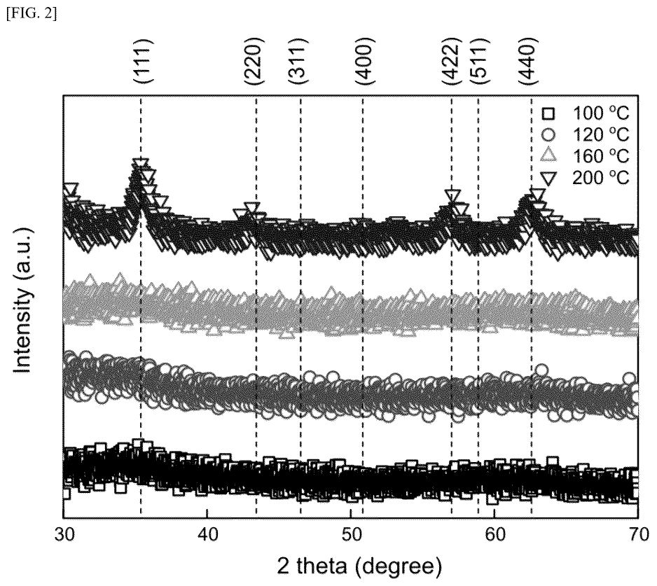

That is, in the present invention, (1) core synthesis is performed in a low-temperature range, and (2) additional heating (up to 300° C.) is performed to synthesize a shell material while simultaneously subjecting the core to subsequent high-temperature treatment, thereby ensuring the crystal characteristics and magnetic properties (saturation magnetization) of core-shell nanoparticles including the low-temperature process at a level comparable to that of two high-temperature single processes. In addition, since core synthesis and shell synthesis are performed continuously in a single reactor, the incorporation of impurities or other oxidation reactions at the interface between the core and the shell may be prevented, enabling efficient production of high-quality core-shell nanoparticles.
(1) In this case, it is preferable to maintain the internal atmosphere by introducing an inert gas (e.g., N₂ or Ar), and to stop the introduction of the inert gas when the specified temperature is reached in order to stably induce nucleation. If the inert gas atmosphere is continuously created without performing the reflux process, the concentration of the precursors will gradually increase over the duration of the reaction due to the continuous evaporation of the solvent, making it difficult to synthesize uniform particles.
(2) Below 180° C., no significant nucleation occurs, but at 180° C. or higher, the iron (Fe) oleate complex formed in step S200 begins to decompose, and full-scale nucleation begins (FIG. 2). In particular, some metal-oleate complexes, such as manganese (Mn) oleate complexes, produced in step S200, decompose at temperatures lower than the decomposition temperature of iron (Fe) oleate, and thus are preferentially doped into the core material in this step. In contrast, complexes that decompose at higher temperatures, such as cobalt (Co) oleate, may be doped only in relatively small amounts in this step.
(3) The core size may vary depending on the molar ratio of the raw materials (precursors) used, the amount of solvent used, the reaction time, etc. For example, when Fe(acac)₃ (3 mmol), 1,2-hexadecanediol (15 mmol), oleic acid (15 mmol), oleylamine (15 mmol), and benzyl ether (30 mL) are reacted, a core with a diameter of about 8.5 nm is synthesized. When the amount of benzyl ether used is increased to 35 mL and 40 mL, cores having diameters of about 6.9 nm and 5.9 nm, respectively, may be obtained, indicating that increasing the solvent leads to a decrease in the particle size. When Fe(acac)₃ (2 mmol) instead of Fe(acac)₃ (3 mmol) is mixed with Co(acac)₂ (1 mmol), a core with a diameter of about 7.5 nm is synthesized at the ratio of Co:Fe=0.42:2.58, indicating that the core composition and size may be controlled depending on the type and mixing ratio of doping metal.

The following describes the shell synthesis process in step S300 in more detail.

In step S300, after the core synthesis process is completed, the single reaction chamber may be heated at a predetermined heating rate to a predetermined temperature range, and maintained at the heated temperature for a predetermined period of time, thereby synthesizing a shell on the outer surface of the core.

In the shell synthesis process in step S300, the predetermined heating rate may be 5 to 10° C./min, the predetermined temperature range may be a temperature range of 280 to 300° C., and the predetermined time during which the heated temperature is maintained may be 30 minutes to 3 hours.
(1) After the core synthesis step is completed, the reaction temperature is increased at a rate of 5 to 10° C./min to a temperature of about 280 to 300° C. or below the boiling point of the solvent. This is because the metal-oleate precursor begins to decompose actively in the range exceeding the temperature at which the core synthesis is performed (about 180 to 200° C.), and if the temperature increase rate is excessively low, the decomposition rate of the metal-oleate may change stepwise in the intermediate temperature range, which may degrade the quality of synthesis. If the temperature is set to lower than 280° C., the difference in composition between the core and the shell becomes insufficient, and thus it is highly likely that nanoparticles including a shell having a composition close to that of the core will be synthesized.
(2) When the predetermined temperature range is reached, all the metal-oleate complexes decompose rapidly and at approximately the same rate. In the core synthesis process (about 180 to 200° C.), iron (Fe) oleate complexes are primarily decomposed, or manganese (Mn) oleate, which decomposes at a lower temperature than iron (Fe) oleate, contributes most to core synthesis. Accordingly, the relative concentration of these metal species remains reduced after core synthesis. On the other hand, cobalt (Co) oleate, which decomposes at a higher temperature than iron (Fe) oleate, is hardly decomposed during the core synthesis step, and thus the relative concentration of the metal species relative to the core remains increased at the time when core synthesis has been completed.

When a temperature range of about 280 to 300° C. is reached, all metal-oleate complexes, including high-temperature decomposable precursors such as cobalt (Co) oleate, react at similar decomposition rates. In this case, the high-temperature decomposable precursors that remained without being completely decomposed in the previous step (core synthesis process) are subsequently deposited onto the nanoparticle surface, selectively synthesizing a shell having a composition different from the core.

Through this stepwise control of the composition, it is possible to realize a multi-layer structure in which each layer (core/shell) has a different magnetic anisotropy constant (Kₐₙᵢ) by applying different doping metals to the core and the shell or applying different contents of the same doping element.

In particular, the interface synthesized so that the magnetic phases are distinguished between the core and the shell as described in the present invention generally induces exchange anisotropy. Typically, exchange anisotropy is inversely proportional to the distance between the interfaces, and the core-shell structure produced by the process of the present invention may exhibit strong exchange anisotropy because the interfacial bonding is very tight. This enhancement of exchange anisotropy acts as a key technological effect that significantly increases the flexibility in magnetic property design by allowing the magnetic anisotropy constant to be controlled over a wider range.

Therefore, in the present invention, it is possible to achieve a more precise and higher level of magnetic anisotropy constant control effect compared to the existing single magnetic phase by simultaneously and comprehensively introducing magnetic anisotropy constant (Kₐₙᵢ) control through doping and an additional energy barrier generated by exchange interaction within a single reaction vessel,

The following example specifically demonstrates that core-shell nanoparticles may be synthesized in the single reaction chamber process of the present invention.

In one example, 3 mmol of iron(III) acetylacetonate, 10 mmol of 1,2-hexadecanediol, 15 mmol of oleic acid, 15 mmol of oleylamine, and 30 ml of benzyl ether were mixed together, and the mixture was heated to a temperature of 190° C. at a heating rate of 10° C./min, and refluxed for 1 hour. Next, the mixture was heated to 290° C. at a heating rate of 3.3° C./min and refluxed for 1 hour, thereby synthesizing a shell of 4.7 nm on a core of about 8.5 nm in diameter, thus synthesizing 13.2-nm core-shell nanoparticles.

In the above example, when 2 mmol of iron(III) acetylacetonate and 1 mmol of cobalt (II) acetylacetonate were used instead of 3 mmol of iron(III) acetylacetonate, a core of Co:Fe=0.42:2.58 having a diameter of about 7.5 nm and a shell of Co:Fe=0.65:2.35 having a thickness of about 5.2 nm were synthesized, thereby synthesizing 12.7-nm core-shell nanoparticles.

By performing core synthesis and shell synthesis sequentially in a single reaction chamber (one-pot), the need to transfer samples during intermediate steps or change the external environment is eliminated, significantly reducing the risk of impurity incorporation or oxide formation. Even if the core and the shell are of the same crystal phase, a defect layer may form at the core-shell boundary depending on the synthesis conditions, and thus exchange interactions may be additionally induced, increasing magnetic anisotropy energy. In addition, when a specific doping metal (Co, Mn, etc.) is used in combination therewith, the magnetic anisotropy constant (Kₐₙᵢ) value may be controlled over a wider range than before, enabling it to respond to various magnetic applications.

Hereinafter, step S400 will be described.

Step S400 according to the present invention is a step of recovering the mixture, synthesized in step S300, from the single reaction chamber, cooling the mixture, and separating nanoparticles from the mixture.

In step S400, the mixture synthesized in step S300 may be recovered from the single reaction chamber, cooled to room temperature, and then precipitated by adding 50 ml of ethanol or isopropyl alcohol (IPA) thereto, and a process of separating nanoparticles therefrom using centrifugation or magnetic separation may be repeated a predetermined number of times.

Step S400 includes cooling the mixture and separating nanoparticles therefrom.

The synthesized mixture is cooled to room temperature, and then precipitated by adding 50 ml of ethanol or isopropyl alcohol (IPA) thereto. Nanoparticles are then separated from the mixture using centrifugation or magnetic separation. This process is repeated 3 to 5 times to remove any residual ligands on the particle surface.

The method of synthesizing core-shell iron oxide nanoparticles through a single process according to the present invention may be widely used in various industrial fields, including biopharmaceuticals, electronic devices, magnetic fluids, and magnetic recording media. For example, the nanoparticles synthesized according to the present invention may be used in medical fields, including drug delivery, MRI contrast agents, and magnetic thermotherapy for cancer treatment. The present invention has great commercial value as it enables mass production, and may contribute to improving the performance of electronic and magnetic data storage devices.

Meanwhile, the present invention may provide core-shell iron oxide nanoparticles. More specifically, the present invention may provide core-shell iron oxide nanoparticles produced by the method of synthesizing core-shell iron oxide nanoparticles through continuous synthesis of the core and the shell in a single reaction chamber.

Hereinafter, the present invention will be described with reference to the accompanying drawings.

FIG. 2 shows temperature-dependent XRD (X-Ray Diffraction) data for confirming the temperature at which core synthesis begins. No crystal structure was observed at 100° C., 120° C., or 160° C., but characteristic diffraction peaks of iron oxide were observed at 200° C. or higher.

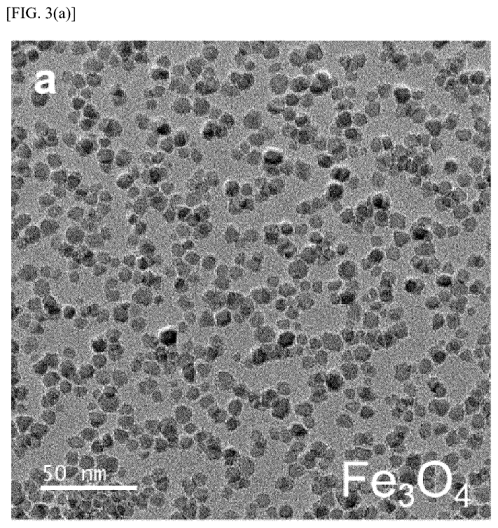

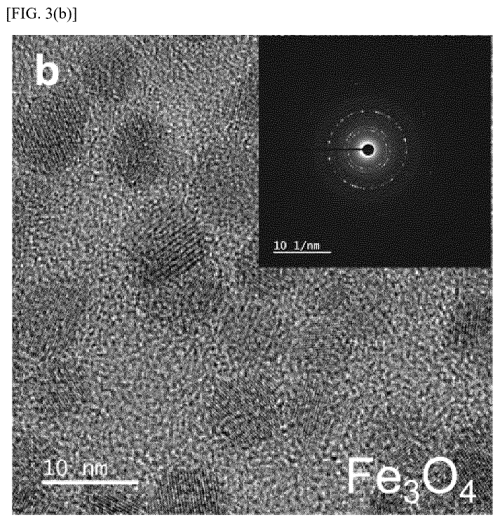

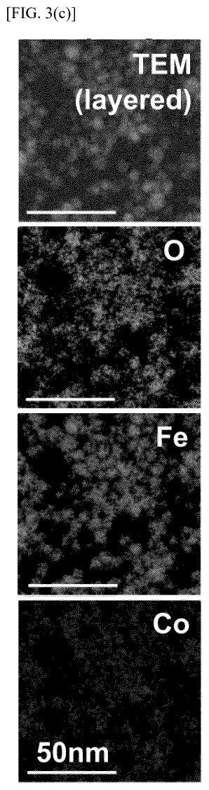

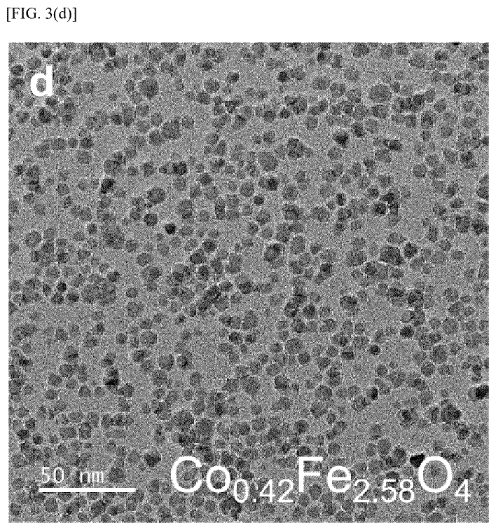

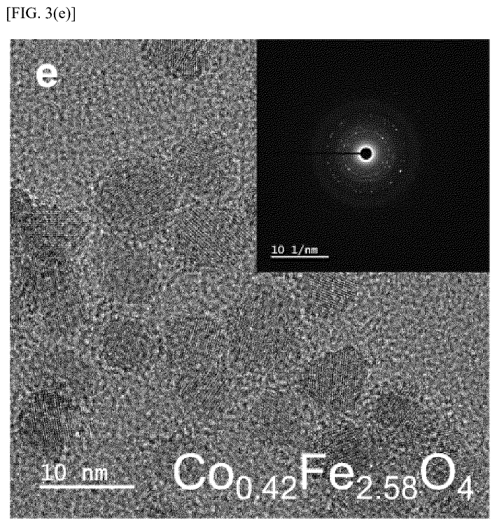

FIG. 3 shows transmission electron microscopy images of formed cores only.

FIG. 3 shows transmission electron microscopy (TEM) images of synthesized iron oxide nanoparticle cores alone.

FIGS. 3a and 3b show TEM images of pure iron oxide nanoparticles, and the size and shape of the nanoparticles can be confirmed in a state where only the core was synthesized.

FIGS. 3d and 3e show TEM images of cobalt-doped iron oxide nanoparticles. It can be confirmed that, when cobalt was doped, changes in the structure and composition of the nanoparticles occurred.

FIG. 3c shows energy dispersive X-ray spectroscopy (EDS) data of cobalt-doped nanoparticles (FIGS. 3d and 3). As shown therein, it can be confirmed that cobalt was doped at a ratio of Co:Fe=0.42:2.58.

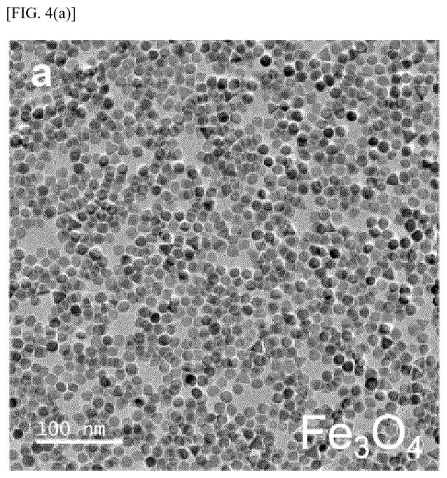

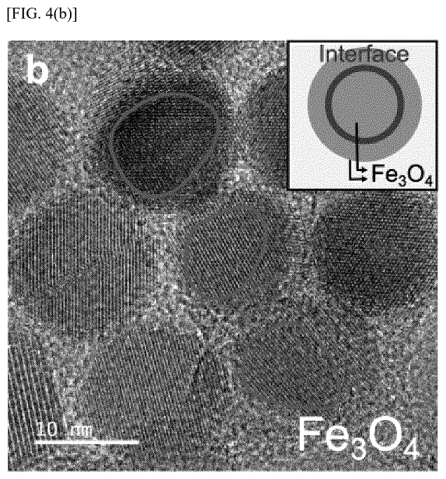

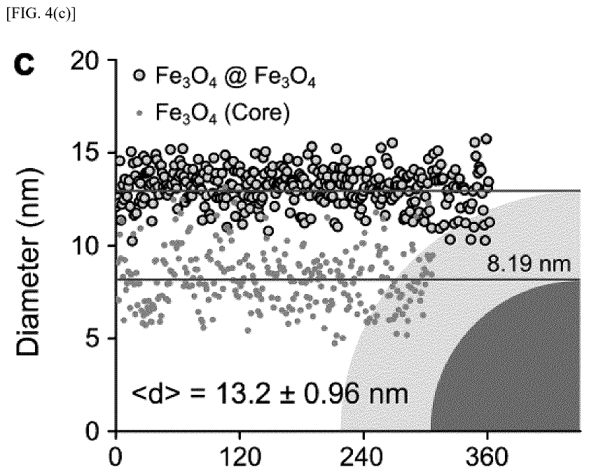

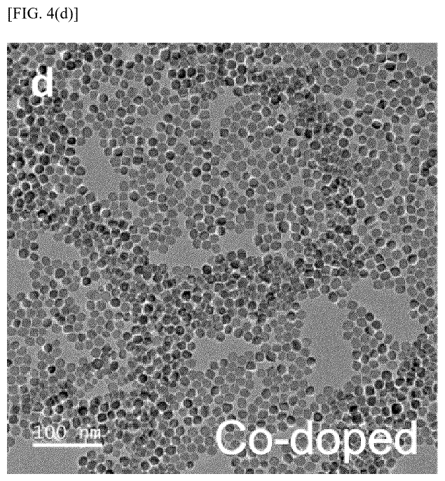

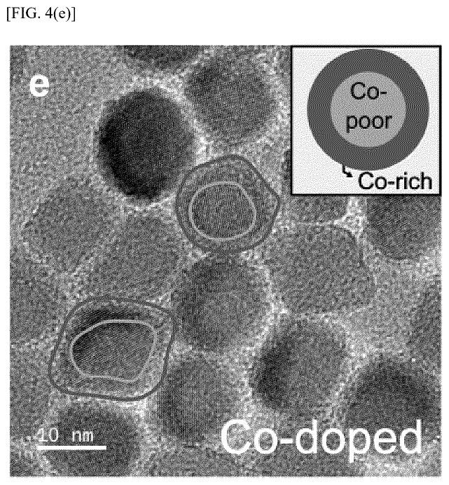

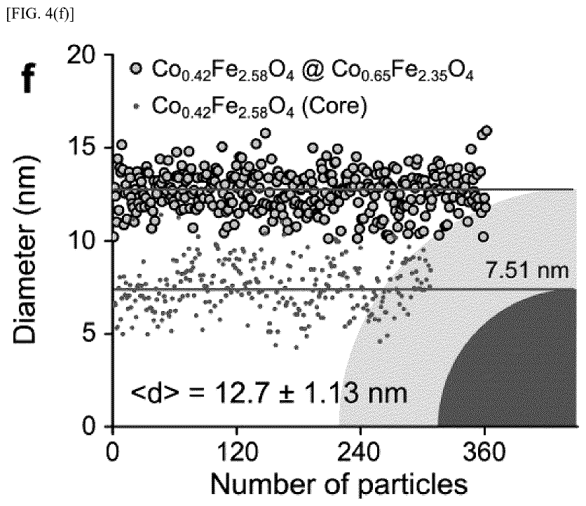

FIG. 4 shows transmission electron microscopy image of synthesized core-shell iron oxide nanoparticles.

FIG. 4 shows transmission electron microscopy (TEM) images and size analysis data of synthesized core-shell iron oxide nanoparticles (synthesized through steps S100, S200, S300 and S400). This allows for visual confirmation and analysis of the size and structure of the nanoparticles.

FIGS. 4a and 4b are TEM images of cobalt-undoped iron oxide nanoparticles, and as shown therein, it can be confirmed that an interface was formed at the core-shell boundary of the nanoparticles. This is a characteristic that appears due to the change in the crystal growth direction of the nanoparticles, and clearly shows the boundary between the core and the shell.

FIG. 4c shows size analysis data for iron oxide nanoparticles. Size changes between synthesized nanoparticle cores alone (gray dots) and nanoparticles after shell synthesis (gray dots with black outlines) were analyzed depending on the number of particles. Through this analysis, it is possible to visually confirm how the size of the nanoparticles changed when only the core was synthesized and when the shell was added.

FIGS. 4d and 4e are TEM images of cobalt-doped iron oxide nanoparticles. Here, a cobalt-poor core and a cobalt-rich shell are distinguished from each other, and the structural difference due to the difference in cobalt concentration is clearly evident. In general, the magnetic anisotropy constant tends to increase in proportion to the cobalt concentration. The presence of a shell with a high magnetic anisotropy constant can enhance the magnetic anisotropy constant of the entire nanoparticle.

FIG. 4f shows size analysis data for cobalt-doped iron oxide nanoparticles. Size changes between synthesized nanoparticle cores alone (light blue dots) and nanoparticles after shell synthesis (light blue dots with black outlines) were analyzed depending on the number of particles. Through this analysis, it is possible to visually confirm how the size of the nanoparticles changed when only the core was synthesized and when the shell was added.

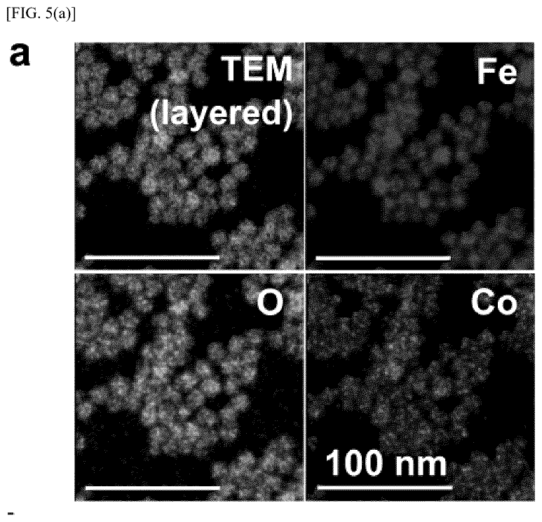

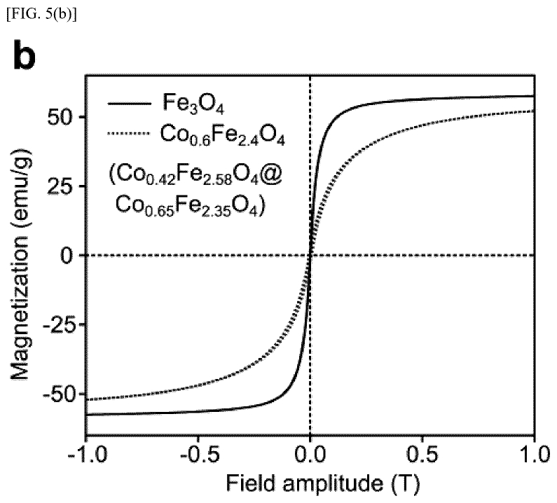

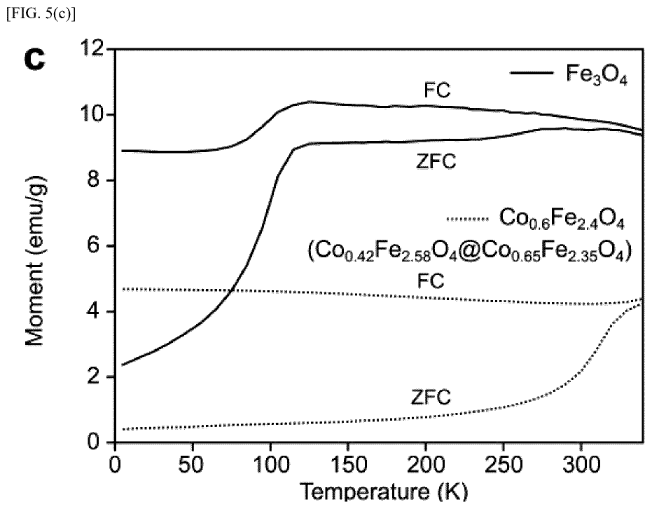

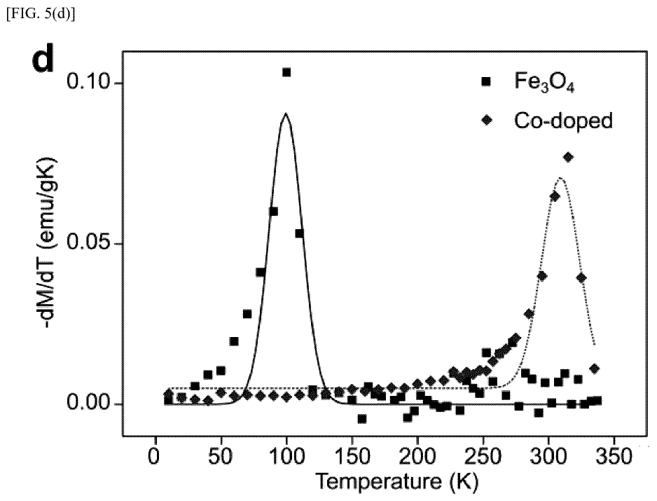

FIG. 5 shows the results of analyzing the magnetic properties of synthesized core-shell iron oxide nanoparticles.

FIG. 5 shows the energy dispersive X-ray spectroscopy (EDS) data of cobalt-doped nanoparticles (FIGS. 5d and 3e). Through the data, it can be confirmed that the overall composition was Co:Fe=0.6:2.4, the core composition was Co:Fe=0.42:2.58, and thus through the core/shell volume ratio, the shell composition was Co:Fe=0.65:2.35, indicating that cobalt was doped.

FIG. 5b shows the magnetic hysteresis curve of synthesized core-shell iron oxide nanoparticles. Through this curve, it is possible to observe how magnetization changes depending on an external magnetic field and to evaluate the magnetic properties of nanoparticles. In particular, it is possible to understand how easily nanoparticles are magnetized and demagnetized in response to a magnetic field.

Cobalt-undoped iron oxide nanoparticles are indicated by the black line, and cobalt-doped iron oxide nanoparticles are indicated by the blue line. Both nanoparticles exhibit superparamagnetic properties with residual magnetization and coercivity close to zero in the curves, and their saturation magnetizations (Ms) were measured to be 53 emu/g and 50 emu/g, respectively.

FIG. 5c shows the zero field cooling (ZFC)—field cooling (FC) curves of synthesized core-shell iron oxide nanoparticles. Here, cobalt-updoped iron oxide nanoparticles are indicated by the black solid line, and cobalt-doped iron oxide nanoparticles are indicated by the blue dotted line. These curves are used to analyze the superparamagnetism and blocking temperature of the nanoparticles.

The ZFC curve was obtained by measuring magnetization in a state in which a magnetic field was applied as the temperature increased after a sample was cooled in the absence of a magnetic field. The ZFC curve indicates the blocking temperature at which nanoparticles transition from paramagnetic to ferromagnetic state at a specific temperature. The FC curve was obtained by measuring magnetization as the temperature increased after a sample was cooled in the presence of a magnetic field. Using the FC curve, the stability of magnetization can be analyzed by measuring the magnetic changes of nanoparticles with temperature changes.

FIG. 5d shows the blocking temperature calculated from the difference between the ZFC and FC curves. Based on this, the magnetic anisotropy constant (K_{eff}) of the nanoparticle can be calculated. The magnetic anisotropy constant is a key parameter that determines the magnetic properties of nanoparticles, indicating how tightly the nanoparticle's magnetization direction is pinned fixed around a specific axis.

The magnetic anisotropy constant of Fe₃O₄@Fe₃O₄ core-shell nanoparticles was calculated to be 53.4 kJ/m³, which is higher than the theoretical value of 16 to 30 kJ/m³. This is because the core-shell structure increased the magnetic anisotropy constant due to the characteristics of the nanoparticles.

The magnetic anisotropy constant of Co_{0.42}Fe_{2.58}O₄@Co_{0.65}Fe_{2.35}O₄ core-shell nanoparticles was 161.8 kJ/m3, indicating that the magnetic anisotropy constant of the nanoparticles was increased rapidly through cobalt doping.

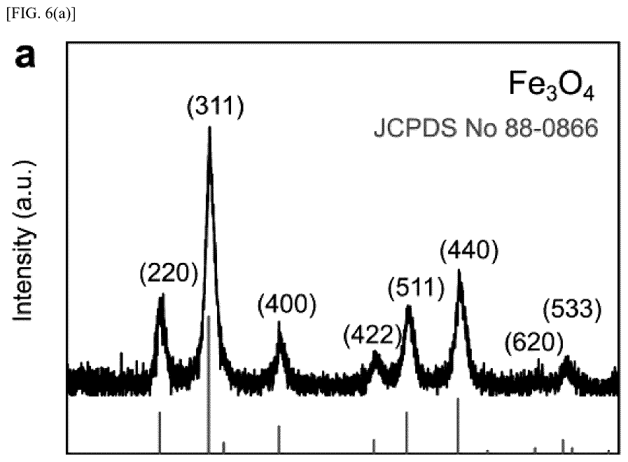

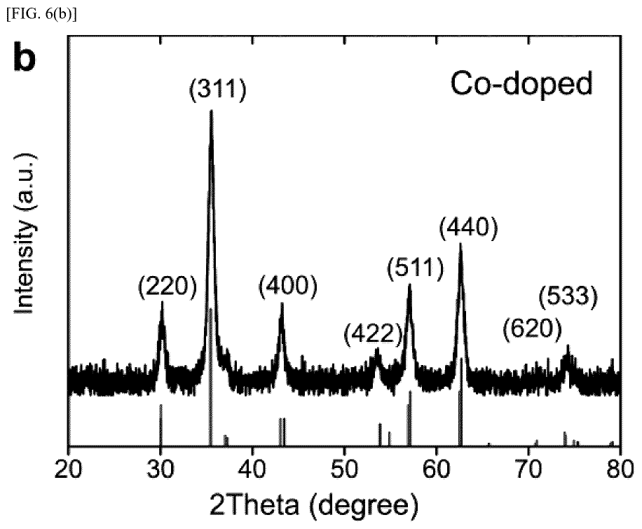

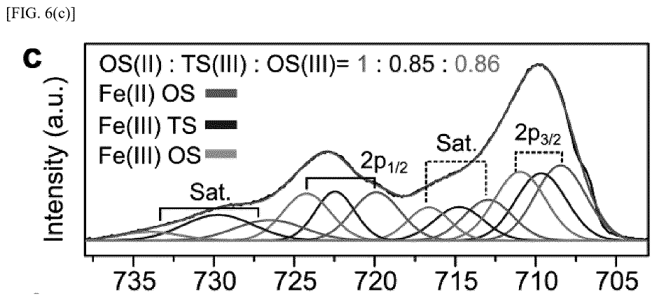

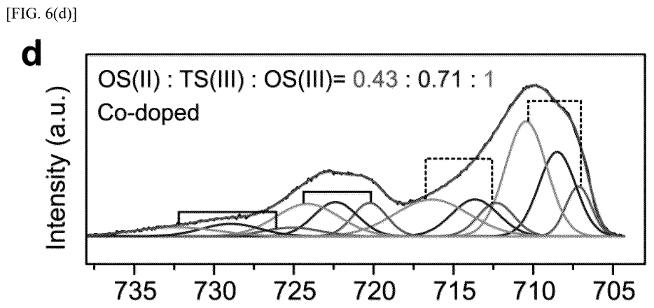

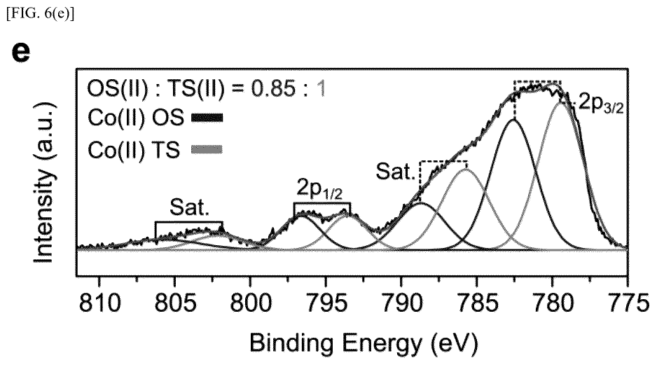

FIG. 6 shows the results of analyzing the chemical properties of synthesized core-shell iron oxide nanoparticles.

FIGS. 6a and 6b show the XRD patterns of Fe₃O₄ nanoparticles (13.2 nm) and cobalt-doped nanoparticles (12.7 nm), obtained through X-ray diffraction (XRD) analysis. Each peak is distinguished by Fe₃O₄(red) and cobalt-doped nanoparticles (blue), and a slight peak shift is observed due to cobalt doping. This indicates that cobalt was doped without significant changes in the crystal structure.

FIGS. 6c, 6d and 6e show the Fe 2p and Co 2p spectra of Fe₃O₄ nanoparticles and cobalt-doped nanoparticles, obtained by X-ray photoelectron spectroscopy (XPS) analysis.

In Fe₃O₄ nanoparticles, the Fe²⁺ 2p_{3/2} peak appeared at 708.4 eV, and the Fe³⁺ 2p_{3/2} peaks appeared at 709.7 eV and 711.0 eV, respectively, and the ratio of Fe²⁺:FE³⁺ (OS):Fe³⁺ (TS) was shown to be 1:0.85:0.86.

In cobalt-doped nanoparticles, the Fe²⁺ 2p_{3/2} peak shifted to 707.2 eV, the Fe³⁺ peaks shifted to 708.5 eV and 710.5 eV, respectively, and the Fe²⁺:FE³⁺ (OS):Fe³⁺ (TS) ratio changed to 0.43:0.71:1.

Additionally, the Co 2p spectrum indicates that Co2+ is distributed in similar proportions at TS and OS, suggesting that the doped nanoparticles get closer to the normal spinel structure.

Through this analysis of the chemical characteristics, it can be confirmed that the core-shell structure was formed as a bilayer structure with a cobalt-poor core and a cobalt-rich shell. EDS analysis of cobalt-doped iron oxide nanoparticles revealed that the Co-rich shell had a composition of Co_{0.65}Fe_{2.35}O₄, while XPS analysis confirmed the surface-sensitive composition was Co_{0.79}Fe_{2.21}O₄. This suggests that more cobalt was doped progressively toward the surface.

Hereinafter, the main features and effects of the present invention will be further explained.

In the present invention, there is no need to transfer a sample to another reactor or expose it to external air during the intermediate step, thus significantly reducing the incorporation of impurities and further oxidation. Consequently, the formation of crystal defects or unnecessary intermediate oxide layers at the core-shell interface is suppressed, resulting in high quality stability and reproducibility of the synthesized nanoparticles.

This increased interfacial stability also significantly contributes to ensuring the uniformity of magnetic properties (magnetization, coercivity, etc.).

In the present invention, by sequentially adjusting the synthesis conditions of the core and shell (temperature, pressure, precursor concentration, gas atmosphere, etc.), the size, shape, and thickness of the nanoparticles forming the core-shell structure can be precisely controlled. Furthermore, it is advantageous for designing magnetic properties that take Brownian motion and Neel motion into account, thereby providing optimal magnetic properties according to desired applications (e.g., medical, catalytic, magnetic sensor, etc.).

In particular, by simultaneously controlling the magnetic anisotropy constant in single nanoparticles through two methods—(1) controlling the magnetocrystalline anisotropy through doping and (2) controlling the exchange anisotropy through the core-shell structure—the magnetic anisotropy constant can be controlled over a wider range, thereby greatly increasing the flexibility in magnetic property design.

The core-shell iron oxide nanoparticles synthesized according to the present invention not only have high purity and high crystallinity, but also have a magnetic anisotropy constant that can be controlled over a wide range to enable resonance at an external frequency, and thus can be widely applied not only in the medical field (e.g., drug delivery, magnetic hyperthermia (thermal therapy for cancer treatment), magnetic resonance imaging (MRI) contrast agents, etc.) but also across industries. In particular, the core-shell structure synthesized through the single-pot process has high interfacial stability, maintaining its chemical and physical stability in various application environments, thereby improving the reliability and reproducibility of the nanoparticles and greatly increasing their utility in the medical and industrial fields.

The embodiments described herein and the accompanying drawings are merely illustrative of some of the technical ideas encompassed by the present invention. Therefore, the embodiments disclosed herein are intended to illustrate, rather than limit, the technical ideas of the present invention. Therefore, it is apparent that the scope of the technical ideas of the present invention is not limited by these embodiments. All modifications and specific embodiments that can be easily conceived of by those skilled in the art within the scope of the technical ideas contained in the specification and drawings of the present invention should be construed as being included within the scope of the rights of the present invention.

What is claimed is:

1. A method of synthesizing core-shell iron oxide nanoparticles through continuous synthesis of the core and the shell in a single reaction chamber, the method comprising:
step S100 of preparing a precursor mixture for synthesizing the core-shell iron oxide nanoparticles;
step S200 of synthesizing oleate complexes using the precursor mixture in the single reaction chamber;
step S300 of sequentially and continuously synthesizing the core and the shell using the oleate complexes, synthesized in step S200, in the single reaction chamber, such a manner that an amount of doping in the shell is large than that in the core; and
step S400 of recovering a mixture synthesized in step S300 from the single reaction chamber, cooling the mixture, and separating the nanoparticles from the mixture.

2. The method of claim 1, wherein the precursor mixture in step S100 contains a mixture of different metal acetylacetonate complexes, a mixture of a polyol reducing agent and oleic acid, and oleylamine at a molar ratio of 1:(3 to 6):(3 to 6) in an organic solvent.

3. The method of claim 2, wherein the mixture of different metal acetylacetonate complexes in step S100 consists of a doping metal acetylacetonate complex and an iron(III) acetylacetonate complex at a molar ratio of 1:2 to 1:5.

4. The method of claim 3, wherein the doping metal (M) in step S100 is in the form of a divalent or trivalent ion, and forms stable complexes, which are the doping metal acetylacetonate complex (M(acac)₂ or M(acac)₃), and a metal oleate complex (M(OL)₂ or M(OL)₃) that is subsequently synthesized.

5. The method of claim 4, wherein the doping metal (M) in step S100 is any one of copper (Cu), nickel (Ni), cobalt (Co), aluminum (Al), or manganese (Mn).

6. The method of claim 2, wherein the polyol reducing agent 15 in step S100 is a dihydric alcohol which is any one of ethylene glycol, diethylene glycol, triethylene glycol, tetraethylene glycol, glycerol, and 1,2-diols having different carbon chain lengths.

7. The method of claim 6, wherein the number of moles (nₚ) of the polyol reducing agent in the mixture of the polyol reducing agent and oleic acid in step S100 is controlled using Equation 5 below in consideration of the mixture consisting of the doping metal acetylacetonate complex and the iron(III) acetylacetonate complex at a molar ratio of 1:2 to 1:5:
$$r = {n}_{p} = \frac{{n}_{3} - 2 {n}_{2}}{3} \qquad ( 5 )$$
n₂ denotes the number of moles of a divalent ion acetylacetonate complex, n₃ denotes the number of moles of a trivalent ion acetylacetonate complex (Fe(acac)₃), nₚ denotes the number of moles of the polyol reducing agent, and r denotes both the number of moles of trivalent ion to be reduced and the number of moles (nₚ) of the polyol reducing agent.

8. The method of claim 2, wherein the oleic acid in step S100 is contained in an amount equal to or larger than the total amount of acetylacetonate ions (acac⁻) contained in the metal acetylacetonate complexes so that all the acetylacetonates are converted to the oleate complexes, but is contained in an amount satisfying Equation 7 below, in which the total number of moles of the polyol reducing agent and the oleic acid is equal to or less than twice the total number of moles of acetylacetonate ligands contained in the metal acetylacetonate complexes:
$$( {n}_{p} + {n}_{0} ) / ( 2 {n}_{2} + 3 {n}_{3} ) \leq 2 \qquad ( 7 )$$
where (nₚ+nₒ) denotes the number of moles of the mixture of the polyol reducing agent and oleic acid, and (2n₂+3n₃) denotes the number of moles of acac ligands, which are acetylacetonate anions.

9. The method of claim 2, wherein the oleylamine in step S100 is contained in an amount satisfying Equation 8 below, in which the number of moles of the oleylamine is equal to or greater than the number of moles of the mixture of the polyol reducing agent and oleic acid, but is equal to or smaller than twice the total number of moles of acetylacetonate ions (acac⁻) contained 5 in the mixture of different metal acetylacetonate complexes:
$${n}_{p} + {n}_{0} \leq {n}_{oa} \leq 2 ( 2 {n}_{2} + 3 {n}_{3} ) \qquad ( 8 )$$
where (nₚ+nₒ) denotes the number of moles of the mixture of the polyol reducing agent and oleic acid, and (2n₂+3n₃) denotes the number of moles of acac ligands, which are acetylacetonate anions.

10. The method of claim 2, wherein the organic solvent in step S100 is an organic solvent that has a boiling point of 295° C. or higher and does not chemically react with an acetylacetonate-based compound during a reaction process.

11. The method of claim 2, wherein the organic solvent in step S100 is contained in an amount ranging from 5.0 to 15.0 L per mol of the mixture of metal acetylacetonate complexes.

12. The method of claim 1, wherein, in step S200, the precursor mixture is introduced into the single reaction chamber and heated to a temperature of 100 to 150° C. for a predetermined period of time, so that the metal acetylacetonate complexes are synthesized into metal oleate complexes.

13. The method of claim 12, wherein, in step S200, the precursor mixture is heated for 1 to 6 hours.

14. The method of claim 12, wherein, in step S200, a reaction solution containing the precursor mixture is stirred at 100 to 1,200 rpm.

15. The method of claim 12, wherein, in step S200, an inert gas is continuously injected at a flow rate of 1 to 500 sccm.

16. The method of claim 1, wherein, in step S300, the single reaction chamber containing the oleate complexes synthesized in step S200 is heated at a predetermined heating rate to a predetermined temperature range, and maintained at the heated temperature for a predetermined time, thereby synthesizing the core while refluxing the reaction solution containing the precursor.

17. The method of claim 16, wherein, in the core synthesis process of step S300, the predetermined heating rate is 1 to 5° C./min, the predetermined temperature range is a range of 180 to 200° C., and the predetermined time during which the heated temperature is maintained is 30 minutes to 1 hour.

18. The method of claim 16, wherein, in the core synthesis process in step S300, an inert gas is introduced, and when a predetermined temperature within the heating temperature range is reached, the introduction of the inert gas is stopped.

19. The method of claim 1, wherein, in step S300, after the core synthesis process is completed, the single reaction chamber is heated at a predetermined heating rate to a predetermined temperature range, and maintained at the heated temperature for a predetermined time, thereby synthesizing the shell on an outer surface of the core.

20. The method of claim 19, wherein, in the shell synthesis process of step S300, the predetermined heating rate is 5 to 10° C./min, the predetermined temperature range is a range of 280 to 300° C., and the predetermined time during which the predetermined temperature is maintained is 30 minutes to 3 hours.

21. The method of claim 1, wherein, in step S400, the mixture synthesized in step S300 is recovered from the single reaction chamber, cooled to room temperature, and then precipitated by adding 50 ml of ethanol or isopropyl alcohol (IPA) thereto, and a process of separating the nanoparticles therefrom using centrifugation or magnetic separation is repeated a predetermined number of times.

22. Core-shell iron oxide nanoparticles produced by the method of claim 1.
